(19) United States
(12) Patent Application Publication
(10) Pub. No.: US 2018/0112087 A1
(43) Pub. Date: Apr. 26, 2018

(54) COATING FORMULATION

(71) Applicant: Agency for Science, Technology and Research, Singapore (SG)

(72) Inventors: Shijie Wang, Singapore (SG); Thiam Min Brian Ong, Singapore (SG); Wee Kwong Na, Singapore (SG); Li Teck Koh, Singapore (SG)

(21) Appl. No.: 15/793,938

(22) Filed: Oct. 25, 2017

(30) Foreign Application Priority Data
Oct. 25, 2016 (SG) 10201609019P

(51) Int. Cl. C09D 7/12; C09D 1/00; B82Y 30/00

(52) U.S. Cl. CPC C09D 7/1291; C09D 7/1216; B82Y 30/00; C09D 1/00; C09D 7/1266

(57) ABSTRACT

The present invention relates to a coating formulation comprising at least one carbonaceous material and a coating material. The present invention also relates to a method for preparing a coating formulation comprising at least one carbonaceous material and a coating material comprising the step of dispersing the at least one carbonaceous material in the coating material.

### TECHNICAL FIELD

The present invention generally relates to a coating formulation comprising at least one carbonaceous material and a coating material. The present invention also relates to a method for preparing the coating formulation as defined herein.

### BACKGROUND ART

Gas turbine engines, fans and impeller for aviation applications require a high level of reliability and a low failure rate in service. Rejection rate of engines is usually high due to the high standard inspection of the engines and stringent criteria applied. Compressor blades are the most commonly rejected components as they are located near the entrance of the engine and suffer from impact and erosion damage. They are frequently damaged by one of the followings: the ingestion of debris, the aggressive high temperature, repeated loading operation environment or combination of these factors. This causes the thinning down of the leading edge, trailing edge and the airfoils and the concomitant impact on the engine performance such as exhaust gas temperature (EGT) margin.

To circumvent the above problems, tungsten carbide (WC) coatings on the blades, which are being deposited by the high velocity oxy-fuel (HVOF) thermal spray technique, have been utilized by the original equipment manufacturer (OEM) and a number of maintenance, repair and overhaul (MRO) repair sources. The use of HVOF for deposition results in denser, well-bonded and low porosity coatings, which may be presumably attributed to the high speeds and relatively low temperatures reached by the particles during the projection as compared to other plasma-based spray processes. The resulting WC coatings provide anti-wear capabilities, corrosion prevention and enhancement of the lifetime.

However, the major disadvantages of the WC coatings, for example WC—Co coatings, are their poor impact resistance, low high cycle fatigue (HCF) lifetime and low fracture toughness. Although thicker coatings may be able to improve the impact resistance, they lead to unfavorable effects such as poor aerodynamic conditions, poor efficiency of the compressor, excessive weight and lower HCF lifetime. Further, HCF failures may occur when some ingestion of foreign objects such as dust, sand and debris, induces nicking of the coupons and subsequently initiates crack propagation. Low fracture toughness can result in a sudden brittle fracture at high stresses, which is highly undesirable. Such low fracture toughness may be attributed to the decarburization and the formation of brittle Co—W—C phases as a consequence of the high temperatures reached during the spray process. A subsequent rapid cooling also decreases the wear resistance due to the tendency to initiate crack which negatively affects the HCF of the blades.

In the above regard, there is a need to provide a coating formulation so that when said coating formulation is applied onto the surface of a substrate, a layer of the coating formulation defined herein overcomes, or at least ameliorates, one or more of the disadvantages described above. The present invention particularly seeks to solve the erosion, decarburization and low HCF of the coatings.

### SUMMARY

In one aspect, the present disclosure relates to a coating formulation comprising at least one carbonaceous material and a coating material.

Advantageously, the presence of carbonaceous materials in the coating formulation as described herein may increase the erosion resistance of the coating. This may be attributed to the denser microstructure and increased hardness of the coating materials.

Further advantageously, the dispersion of the carbonaceous material as defined above using a suitable mixing method (such as roller milling) into the coating precursor may not result in the creation of new phases, which may decarburize the coatings. Hence, the reduction in the decarburization increases the wear resistance of the coatings.

Still advantageously, the addition of the carbonaceous material via a suitable method may increase HCF lifetime of the coatings.

Yet advantageously, a layer of the coating formulation above on the surface of the substrate may result in enhanced resistance to stress fractures, increased creep resistance and fatigue lifetime, in comparison to a coated surface of similar substrate using similar coating material, but devoid of the carbonaceous material.

Still advantageously, the coating formulation, when applied onto the surface of a suitable substrate, may produce coated substrate with a better surface finish and an enhanced lubricity of the coating surface thereby promoting smooth airflow over the surface.

Further advantageously, the coating formulation, when applied onto the surface of a suitable substrate, may produce coated substrate with increased resistance of corrosion.

Advantageously, the coating formulation as defined herein, when applied onto a suitable substrate, may have a higher temperature capability (i.e. higher temperature resistance) in comparison to the coated substrate using similar coating material but in the absence of the carbonaceous material.

Since the substrate coated by the above coating formulation may exhibit the above advantages, the coated substrate may therefore reduce the service and maintenance cost.

In another aspect, the present disclosure relates to a method for preparing a coating formulation comprising at least one carbonaceous material and a coating material, comprising the step of dispersing the at least one carbonaceous material in a coating precursor.

Advantageously, the deposition time required to prepare the coated substrate using the above coating formulation may be comparable with the same method or other methods using the coating formulation known in the art.

In another aspect, the present disclosure relates to a substrate coated by a layer of a coating formulation, wherein the coating formulation comprises at least one carbonaceous material and a coating material.

Advantageously, the substrate coated by a layer of the coating formulation as defined above may exhibit at least one of the following properties (when compared to a coated substrate but without the carbonaceous material):
improved resistance to corrosion;
reduced decarburization of the coating;
improved high cycle fatigue (HCF);
improved resistance to stress fractures;
increased creep resistance and fatigue lifetime;
better surface finish; and
high temperature capability.

In another aspect, the present disclosure relates to a process for preparing a coating slurry onto the surface of a substrate, wherein the coating slurry comprising at least one carbonaceous material and a coating material.

### Definitions

The following words and terms used herein shall have the meaning indicated:

The term ‘carbon nanotube’ or TNT′ as defined herein refers to various tubes or fibers, particularly carbon fibers, having very small diameters including fibrils, whiskers, buckytubes, and so on.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Exemplary, non-limiting embodiments of a coating formulation comprising at least one carbonaceous material and a coating material, will now be disclosed.

The at least one carbonaceous material as defined herein may be selected from the group consisting of a carbon nanotube (CNT), fullerene, graphite or combinations thereof. It is to be understood that when different carbonaceous material is added to the coating material, a layer of the coating formulation comprising the at least one carbonaceous material as defined above and the coating material may have different mechanical properties such as mechanical strength.

The carbon nanotube (CNT) above may be selected from a single-walled carbon nanotube (SWNT), double-walled carbon nanotube (DWNT), multi-walled carbon nanotube (MWNT), inorganic nanotube, multibranched nanotube or combinations thereof.

The particle size of the CNT used herein may be defined in terms of its outer diameter, its length or both its outer diameter and length. The outer diameter of the CNT used in the present disclosure may be in the range of about 8 to 15 nm, about 8 nm, about 9 nm, about 10 nm, about 11 nm, about 12 nm, about 13 nm, about 14 nm or about 15 nm. The CNT as defined herein may have a length in the range of about 10 μm to 30 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, or about 30 μm.

When carbon nanotube (CNT) is used as the at least one carbonaceous material, the CNT may undergo a functionalization, that is, new functional groups are formed on the CNT thus producing a functionalized carbon nanotube (CNT). Without being bound by theory, such functionalization may occur at the surface, bulk or both surface and bulk of the CNT. Preferred functionalization may occur at the surface of the CNT and therefore such CNT is termed as a surface-functionalized CNT. Similarly, if other carbonaceous material is used, said carbonaceous material is then termed as surface-functionalized carbonaceous material such as surface-functionalized fullerene or surface-functionalized graphite.

The functionalization above may be undertaken using a wet treatment, which typically involves a chemical reaction. The functionalization via the chemical treatment may be achieved by refluxing the CNT in a suitable acid or in the presence of a mixture of two or more acids for a period of time. The acid used in the chemical treatment above may include acid commonly known in the art such as a monoprotic acid, a diprotic acid, or a polyprotic acid. Such acid may be a strong acid, a weak acid, an inorganic acid, an organic acid or mixtures thereof.

The functionalization as defined above advantageously may not require a dry treatment, which involves the use of plasma for example. Hence, the functionalization excludes the requirement for having gas plasma or organic vapour plasma.

Non-limiting examples of the acid used in the chemical treatment may include nitric acid, sulphuric acid, hydrochloric acid, oxalic acid, phosphoric acid, citric acid, carboxylic acid such as formic acid and acetic acid. The above chemical treatment may use one or more acids as defined above. The chemical treatment as defined herein may promote the dispersion of CNT in a solvent or a mixture of two or more solvents. Hence, the functionalized CNT may undergo a better dispersion or homogeneous dispersion when said CNT is dispersed in a solvent. The chemical treatment may also result in an improved hydrophilicity of the CNT since one or more functional groups may be formed upon functionalization. Therefore, when dispersed in an aqueous medium, the functionalized CNT may not undergo agglomeration.

The solvent used above may be aqueous or non-aqueous (organic) solvent. Non-limiting examples of such solvents include water, aqueous salt solution, methanol, ethanol, 1-propanol, 2-propanol, 1-butanol, 2-butanol, tert-butyl alcohol, acetonitrile, dimethyl sulfoxide (DMSO), hexane, cyclohexane, benzene, acetic acid, chloroform, diethyl ether, diethylene glycol, ethyl acetate, and combinations thereof.

The functional group that may be formed as a result of the chemical treatment as defined above may include one or more OH groups, carboxyl, phenol, lactol and mixture thereof. The examples of the functional group provided here are not limiting and therefore may extend to other commonly known functional groups. Therefore, if the new functional group formed is OH groups, it is to be understood that the presence of one or more OH groups at the surface of CNT may render the functionalized CNT to have a better dispersibility in water due to for example the formation of hydrogen bonding with water molecules and therefore CNT agglomeration may be prevented.

The concentration of the acid or the mixture of two or more acids in the chemical treatment as described herein may be in the range of about 50% to 95% (by weight), about 50% to about 60%, about 50% to about 70%, about 50% to about 75%, about 50% to about 80%, about 50% to about 90%, about 60% to about 70%, about 60% to about 75%, about 60% to about 80%, about 60% to about 90%, about 60% to about 95%, about 70% to about 75%, about 70% to about 80%, about 70% to about 90%, about 70% to about 95%, about 75% to about 80%, about 75% to about 90%, about 75% to about 95%, about 80% to about 90%, or about 90% to about 95%.

The refluxing step as defined herein may be undertaken for a period in the range of about 10 minutes to about 10 hours, about 10 minutes to about one hour, about 10 minutes to about two hours, about 10 minutes to about three hours, about 10 minutes to about four hours, about 10 minutes to about five hours, about 10 minutes to about 6 hours, about 10 minutes to about 8 hours, about one hour to about two hours, about one hour to about three hours, about one hour to about four hours, about one hour to about five hours, about one hour to about 6 hours, about one hour to about 8 hours, about two hours to about three hours, about two hours to about four hours, about two hours to about five hours, about two hours to about 6 hours, about two hours to about 8 hours, about two hours to about 10 hours, about three hours to about four hours, about three hours to about five hours, about three hours to about 6 hours, about three hours to about 8 hours, about three hours to about 10 hours, about four hours to about five hours, about four hours to about 6 hours, about four hours to about 8 hours, about four hours to about 10 hours, about five hours to about 6 hours, about five hours to about 8 hours, about five hours to about 10 hours, about 6 hours to about 8 hours, about 6 hours to about 10 hours, or about 8 hours to about 10 hours.

The refluxing step of the carbonaceous material or CNT undertaken in the presence of one or more acids as defined above may afford a suspension comprising a complete or partial functionalization of the carbonaceous material or CNT. In any case, it is to be understood that the pH of the resulting suspension may be within the acidic range that is pH of the suspension below 7. Therefore, for further use, the suspension comprising the functionalized carbonaceous material or functionalized CNT may be subjected to a washing cycle to afford the suspension having a neutral pH. Such washing cycle may require one, two, three, four or five cycles of washing, preferably at least three cycles of washing. The number of cycle here is not limited to five cycles. Hence, it may be repeated as many as possible to ensure that the final pH of the suspension is about 7. When the pH of the suspension is about 7, it is to be understood that this suspension is substantially free of the acid or mixture of acids previously used for the functionalization.

The washing step defined herein may be undertaken using a suitable solvent. Therefore, a single solvent or a mixture of two or more solvents as defined above may be used in the washing step. Suitable solvent for washing may include water and aqueous salt solution. It is understood that the washing step above may involve separating the solvent used for washing from the solid product that is functionalized carbonaceous material or functionalized CNT. As indicated above, the functionalized carbonaceous material or functionalized CNT may be surface-functionalized carbonaceous material or surface-functionalized CNT.

Once the pH of the suspension comprising the functionalized carbonaceous material or functionalized CNT has been adjusted to around 7, the suspension as defined herein may be dried prior to further use. The drying step here may be undertaken using a method known in the art as long as this drying step is capable of substantially removing the solvent by evaporation from the solid. Typical drying process described above may involve the supply of heat. Hence, said drying process may involve the use of a gas stream such as air, which applies the heat by convection and carries away the vapor as humidity or vacuum drying where the heat is supplied by conduction or radiation (or microwaves), while the vapor produced is removed by the vacuum system. The examples above are non-limiting and therefore other suitable drying techniques such as freeze drying may also be used.

The drying step described above may be undertaken at a temperature in the range of about 30° C. to about 80° C., about 30° C. to about 40° C., about 30° C. to about 50° C., about 30° C. to about 60° C., about 30° C. to about 70° C., about 40° C. to about 50° C., about 40° C. to about 60° C., about 40° C. to about 70° C., about 40° C. to about 80° C., about 50° C. to about 60° C., about 50° C. to about 70° C., about 50° C. to about 80° C., about 60° C. to about 70° C., about 60° C. to about 80° C., or about 70° C. to about 80° C.

The drying step described herein may be undertaken at a period in the range of about one hour to about 24 hours, about one hour to about two hours, about one hour to about 3 hours, about one hour to about 6 hours, about one hour to about 9 hours, about one hour to about 12 hours, about one hour to about 18 hours, about two hours to about three hours, about two hours to about 6 hours, about two hours to about 9 hours, about two hours to about 12 hours, about two hours to about 18 hours, about two hours to about 24 hours, about three hours to about 6 hours, about three hours to about 9 hours, about three hours to about 12 hours, about three hours to about 18 hours, about three hours to about 24 hours, about 6 hours to about 9 hours, about 6 hours to about 12 hours, about 6 hours to about 18 hours, about 6 hours to about 24 hours, about 9 hours to about 12 hours, about 9 hours to about 18 hours, about 9 hours to about 24 hours, about 12 hours to about 18 hours, about 12 hours to about 24 hours, or about 18 hours to about 24 hours.

As stated above, the coating formulation of the present disclosure may also comprise the coating material. Such coating material may be selected from the group consisting of tungsten carbide (WC), WC-metal, titanium carbide, titanium nitride, silicon carbide, boron nitrate, rhenium diboride, titanium diboride and combinations thereof. When WC-metal is used as the coating material, the metal may be a transition metal selected from groups 3, 4, 5, 6, 7, 8, 9, 10, 11 or 12 of the Periodic Table of Elements. Non-limiting examples of the transition metal include scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, or combinations thereof. The preferred coating material used in the coating formulation as defined herein may be tungsten carbide-cobalt (WC—Co).

If the metal in the WC-metal is a transition metal, such transition metal may be present in the range of about 1 wt % to about 25 wt %, about 1 wt % to about 5 wt %, about 1 wt % to about 10 wt %, about 1 wt % to about 15 wt %, about 1 wt % to about 17 wt %, about 1 wt % to about 20 wt %, about 5 wt % to about 10 wt %, about 5 wt % to about 15 wt %, about 5 wt % to about 17 wt %, about 5 wt % to about 20 wt %, about 5 wt % to about 25 wt %, about 10 wt % to about 15 wt %, about 10 wt % to about 17 wt %, about 10 wt % to about 20 wt %, about 10 wt % to about 25 wt %, about 15 wt % to about 17 wt %, about 15 wt % to about 20 wt %, about 15 wt % to about 25 wt %, about 17 wt % to about 20 wt %, about 17 wt % to about 25 wt %, or about 20 wt % to about 25 wt %, based on the total weight of the WC-metal. Preferred amount of the transition metal may be about 17 wt %. Therefore, the preferred amount of the tungsten carbide-cobalt (WC—Co) may be about 17 wt %.

The at least one carbonaceous material in the coating formulation as defined herein may be present in the range of about 0.05 wt % to about 5 wt %, about 0.05 wt % to about 0.1 wt %, about 0.05 wt % to about 0.2 wt %, about 0.05 wt % to about 0.5 wt %, about 0.05 wt % to about 1 wt %, about 0.05 wt % to about 1.5 wt %, about 0.05 wt % to about 2 wt %, about 0.05 wt % to about 3 wt %, about 0.05 wt % to about 4 wt %, about 0.1 wt % to about 0.2 wt %, about 0.1 wt % to about 0.5 wt %, about 0.1 wt % to about 1 wt %, about 0.1 wt % to about 1.5 wt %, about 0.1 wt % to about 2 wt %, about 0.1 wt % to about 3 wt %, about 0.1 wt % to about 4 wt %, about 0.1 wt % to about 5 wt %, about 0.2 wt % to about 0.5 wt %, about 0.2 wt % to about 1 wt %, about 0.2 wt % to about 1.5 wt %, about 0.2 wt % to about 2 wt %, about 0.2 wt % to about 3 wt %, about 0.2 wt % to about 4 wt %, about 0.2 wt % to about 5 wt %, about 0.5 wt % to about 1 wt %, about 0.5 wt % to about 1.5 wt %, about 0.5 wt % to about 2 wt %, about 0.5 wt % to about 3 wt %, about 0.5 wt % to about 4 wt %, about 0.5 wt % to about 5 wt %, about 1 wt % to about 1.5 wt %, about 1 wt % to about 2 wt %, about 1 wt % to about 3 wt %, about 1 wt % to about 4 wt %, about 1 wt % to about 5 wt %, about 1.5 wt % to about 2 wt %, about 1.5 wt % to about 3 wt %, about 1.5 wt % to about 4 wt %, about 1.5 wt % to about 5 wt %, about 2 wt % to about 3 wt %, about 2 wt % to about 4 wt %, about 2 wt % to about 5 wt %, about 3 wt % to about 4 wt %, about 3 wt % to about 5 wt %, or about 4 wt % to about 5 wt %, based on the total weight of the coating formulation.

Exemplary, non-limiting embodiments of a method for preparing a coating formulation comprising at least one carbonaceous material and a coating material, will now be disclosed.

The present disclosure provides a method for preparing a coating formulation comprising at least one carbonaceous material and a coating material comprising the step of dispersing the at least one carbonaceous material in the coating material.

As defined herein, the at least one carbonaceous material of the coating formulation formed by the above method may be selected from the group consisting of a carbon nanotube (CNT), fullerene, graphite or combinations thereof.

The carbon nanotube (CNT) above may be selected from a single-walled carbon nanotube (SWNT), double-walled carbon nanotube (DWNT), multi-walled carbon nanotube (MWNT), inorganic nanotube, multibranched nanotube or combinations thereof.

The particle size of the CNT used in the method for preparing the coating formulation described herein may be similar to that of the CNT described in the previous section.

The CNT used as the at least one carbonaceous material may undergo the functionalization as described above. Typically upon functionalization, new functional groups are formed on the CNT thus producing a functionalized carbon nanotube (CNT). Without being bound by theory, such functionalization may occur at the surface, bulk or both surface and bulk of the CNT. Preferred functionalization may occur at the surface of the CNT and therefore such CNT is termed as a surface-functionalized CNT. Similarly, if other carbonaceous material is used, said carbonaceous material is then termed as surface-functionalized carbonaceous material such as surface-functionalized fullerene and surface-functionalized graphite.

The functionalization above may be undertaken using a wet treatment, which typically involves a chemical reaction. The functionalization via the chemical treatment may be achieved by refluxing the CNT in a suitable acid or in the presence of a mixture of two or more acids for a period of time. The acid used in the chemical treatment above may include acid commonly known in the art such as a monoprotic acid, a diprotic acid, or a polyprotic acid. Such acid may be a strong acid, a weak acid, an inorganic acid, an organic acid or mixtures thereof.

The functionalization as defined above advantageously may not require a dry treatment, which involves the use of plasma for example. Hence, the functionalization excludes the requirement for having gas plasma or organic vapour plasma.

Non-limiting examples of the acid used in the chemical treatment may include nitric acid, sulphuric acid, hydrochloric acid, oxalic acid, phosphoric acid, citric acid, carboxylic acid such as formic acid and acetic acid. The above chemical treatment may use one or more acids as defined above. The chemical treatment as defined herein may promote the dispersion of CNT in a solvent or a mixture of two or more solvents. Hence, the functionalized CNT may undergo a better dispersion or homogeneous dispersion when said CNT is dispersed in a solvent. The chemical treatment may also result in an improved hydrophilicity of the CNT since one or more functional groups may be formed upon functionalization. Therefore, when dispersed in an aqueous medium, the functionalized CNT may not undergo an agglomeration.

The functional group that may be formed as a result of the chemical treatment as defined above may include one or more OH groups, carboxyl, phenol, lactol and mixture thereof. The examples of the functional group provided here are not limiting and therefore may extend to other commonly known functional groups. Therefore, if the new functional group formed is OH groups, it is to be understood that the presence of one or more OH groups at the surface of CNT may render the functionalized CNT to have a better dispersibility in water due to the formation of hydrogen bonding with water molecules and therefore CNT agglomeration may be prevented.

The concentration of the acid or the mixture of two or more acids in the chemical treatment as described herein may be in the range of about 50% to about 95% (by weight), about 50% to about 60%, about 50% to about 70%, about 50% to about 75%, about 50% to about 80%, about 50% to about 90%, about 60% to about 70%, about 60% to about 75%, about 60% to about 80%, about 60% to about 90%, about 60% to about 95%, about 70% to about 75%, about 70% to about 80%, about 70% to about 90%, about 70% to about 95%, about 75% to about 80%, about 75% to about 90%, about 75% to about 95%, about 80% to about 90%, or about 90% to about 95%.

The refluxing step as defined herein may be undertaken for a period in the range of about 10 minutes to about 10 hours, about 10 minutes to about one hour, about 10 minutes to about two hours, about 10 minutes to about three hours, about 10 minutes to about four hours, about 10 minutes to about five hours, about 10 minutes to about 6 hours, about 10 minutes to about 8 hours, about one hour to about two hours, about one hour to about three hours, about one hour to about four hours, about one hour to about five hours, about one hour to about 6 hours, about one hour to about 8 hours, about two hours to about three hours, about two hours to about four hours, about two hours to about five hours, about two hours to about 6 hours, about two hours to about 8 hours, about two hours to about 10 hours, about three hours to about four hours, about three hours to about five hours, about three hours to about 6 hours, about three hours to about 8 hours, about three hours to about 10 hours, about four hours to about five hours, about four hours to about 6 hours, about four hours to about 8 hours, about four hours to about 10 hours, about five hours to about 6 hours, about five hours to about 8 hours, about five hours to about 10 hours, about 6 hours to about 8 hours, about 6 hours to about 10 hours, or about 8 hours to about 10 hours.

The refluxing step of the carbonaceous material or CNT undertaken in the presence of one or more acids as defined above may afford a suspension comprising a complete or partial functionalization of the carbonaceous material or CNT. In any case, it is to be understood that the pH of the resulting suspension may be within the acidic range that is pH of the suspension below 7. Therefore, for further use, the suspension comprising the functionalized carbonaceous material or functionalized CNT may be subjected to a washing cycle to afford the suspension having a neutral pH. Such washing cycle may require one, two, three, four or five cycles of washing, preferably at least three cycles of washing. The number of cycle here is not limited to five cycles. Hence, it may be repeated as many as possible to ensure that the final pH of the suspension is about 7. When the pH of the suspension is about 7, it is to be understood that this suspension is substantially free of the acid or mixture of acids previously used for the functionalization.

The washing step defined herein may be undertaken using a suitable solvent. Therefore, a single solvent or a mixture of two or more solvents may be used in the washing step. Suitable solvent for washing may include water and aqueous salt solution. It is understood that the washing step above may involve separating the solvent used for washing from the solid product that is functionalized carbonaceous material or functionalized CNT. As indicated above, the functionalized carbonaceous material or functionalized CNT may be surface-functionalized carbonaceous material or surface-functionalized CNT.

Once the pH of the suspension comprising the functionalized carbonaceous material or functionalized CNT has been adjusted to around 7, the suspension as defined herein may be dried prior to further use. The drying step here may be undertaken using a method known in the art as long as this drying step is capable of substantially removing the solvent by evaporation from the solid. Typical drying process described above may involve the supply of heat. Hence, said drying process may involve the use of a gas stream such as air, which applies the heat by convection and carries away the vapor as humidity or vacuum drying where the heat is supplied by conduction or radiation (or microwaves), while the vapor produced is removed by the vacuum system. The examples above are non-limiting and therefore other suitable drying techniques such as freeze drying may also be used.

The drying step described above may be undertaken at a temperature in the range of about 30° C. to about 80° C., about 30° C. to about 40° C., about 30° C. to about 50° C., about 30° C. to about 60° C., about 30° C. to about 70° C., about 40° C. to about 50° C., about 40° C. to about 60° C., about 40° C. to about 70° C., about 40° C. to about 80° C., about 50° C. to about 60° C., about 50° C. to about 70° C., about 50° C. to about 80° C., about 60° C. to about 70° C., about 60° C. to about 80° C., or about 70° C. to about 80° C.

The drying step described herein may be undertaken at a period in the range of about one hour to about 24 hours, about one hour to about two hours, about one hour to about 3 hours, about one hour to about 6 hours, about one hour to about 9 hours, about one hour to about 12 hours, about one hour to about 18 hours, about two hours to about three hours, about two hours to about 6 hours, about two hours to about 9 hours, about two hours to about 12 hours, about two hours to about 18 hours, about two hours to about 24 hours, about three hours to about 6 hours, about three hours to about 9 hours, about three hours to about 12 hours, about three hours to about 18 hours, about three hours to about 24 hours, about 6 hours to about 9 hours, about 6 hours to about 12 hours, about 6 hours to about 18 hours, about 6 hours to about 24 hours, about 9 hours to about 12 hours, about 9 hours to about 18 hours, about 9 hours to about 24 hours, about 12 hours to about 18 hours, about 12 hours to about 24 hours, or about 18 hours to about 24 hours.

As stated above, the coating formulation of the present disclosure may also comprise the coating material. Such coating material may be selected from the group consisting of tungsten carbide (WC), WC-metal, titanium carbide, titanium nitride, silicon carbide, boron nitrate, rhenium diboride, titanium diboride and combinations thereof. When WC-metal is used as the coating material, the metal may be a transition metal selected from groups 3, 4, 5, 6, 7, 8, 9, 10, 11 or 12 of the Periodic Table of Elements. Non-limiting examples of the transition metal include scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, or combinations thereof. The preferred coating material used in the coating formulation as defined herein may be tungsten carbide-cobalt (WC—Co).

If the metal in the WC-metal is a transition metal, such transition metal may be present in the range of about 1 wt % to about 25 wt %, about 1 wt % to about 5 wt %, about 1 wt % to about 10 wt %, about 1 wt % to about 15 wt %, about 1 wt % to about 17 wt %, about 1 wt % to about 20 wt %, about 5 wt % to about 10 wt %, about 5 wt % to about 15 wt %, about 5 wt % to about 17 wt %, about 5 wt % to about 20 wt %, about 5 wt % to about 25 wt %, about 10 wt % to about 15 wt %, about 10 wt % to about 17 wt %, about 10 wt % to about 20 wt %, about 10 wt % to about 25 wt %, about 15 wt % to about 17 wt %, about 15 wt % to about 20 wt %, about 15 wt % to about 25 wt %, about 17 wt % to about 20 wt %, about 17 wt % to about 25 wt %, or about 20 wt % to about 25 wt %, based on the total weight of the WC-metal. Preferred amount of the transition metal may be about 17 wt %. Therefore, the preferred amount of the tungsten carbide-cobalt (WC—Co) may be about 17 wt %.

The at least one carbonaceous material in the coating formulation as defined herein may be present in the range of about 0.05 wt % to about 5 wt %, about 0.05 wt % to about 0.1 wt %, about 0.05 wt % to about 0.2 wt %, about 0.05 wt % to about 0.5 wt %, about 0.05 wt % to about 1 wt %, about 0.05 wt % to about 1.5 wt %, about 0.05 wt % to about 2 wt %, about 0.05 wt % to about 3 wt %, about 0.05 wt % to about 4 wt %, about 0.1 wt % to about 0.2 wt %, about 0.1 wt % to about 0.5 wt %, about 0.1 wt % to about 1 wt %, about 0.1 wt % to about 1.5 wt %, about 0.1 wt % to about 2 wt %, about 0.1 wt % to about 3 wt %, about 0.1 wt % to about 4 wt %, about 0.1 wt % to about 5 wt %, about 0.2 wt % to about 0.5 wt %, about 0.2 wt % to about 1 wt %, about 0.2 wt % to about 1.5 wt %, about 0.2 wt % to about 2 wt %, about 0.2 wt % to about 3 wt %, about 0.2 wt % to about 4 wt %, about 0.2 wt % to about 5 wt %, about 0.5 wt % to about 1 wt %, about 0.5 wt % to about 1.5 wt %, about 0.5 wt % to about 2 wt %, about 0.5 wt % to about 3 wt %, about 0.5 wt % to about 4 wt %, about 0.5 wt % to about 5 wt %, about 1 wt % to about 1.5 wt %, about 1 wt % to about 2 wt %, about 1 wt % to about 3 wt %, about 1 wt % to about 4 wt %, about 1 wt % to about 5 wt %, about 1.5 wt % to about 2 wt %, about 1.5 wt % to about 3 wt %, about 1.5 wt % to about 4 wt %, about 1.5 wt % to about 5 wt %, about 2 wt % to about 3 wt %, about 2 wt % to about 4 wt %, about 2 wt % to about 5 wt %, about 3 wt % to about 4 wt %, about 3 wt % to about 5 wt %, or about 4 wt % to about 5 wt %, based on the total weight of the coating formulation.

Hence, there is provided in the disclosure a method for preparing a coating formulation comprising the surface-functionalized CNT and WC—Co comprising the step of dispersing the surface-functionalized CNT in WC—Co.

The method of preparing the coating formulation may further comprise the step of milling the dispersion obtained above to reduce the particle size of the at least one carbonaceous material and the coating material to form a coating slurry.

The milling step above may be undertaken in a milling device commonly used in the art that may include roller mill, ball mill and hammer mills. Such milling step may be in the form of dry milling or wet milling. The milling process here may facilitate a homogeneous mixing between the at least one carbonaceous material and a coating material. In any of the forms described here, at least one grinding medium may be required. The at least one grinding medium may be selected from the grinding media known such as ceramic, plastic, steel and glass media. Suitability of the grinding media here may depend on several factors: i) chemical compatibility; ii) physical compatibility; iii) grinding media density; and iv) grinding bead diameter.

Preferred grinding media used for the above method may be selected from those that do not introduce any chemical contamination, do not wear more rapidly as compared to the materials being ground, and those that have a grinding bead diameter nearing to that of the materials being ground. The use of grinding media above may facilitate mixing of the materials being ground, hence the size-reducing process may proceed with a higher efficiency.

The grinding media as defined above have a particle size in the range of about 1 mm to about 10 mm, about 1 mm to about 2 mm, about 1 mm to about 3 mm, about 1 mm to about 4 mm, about 1 mm to about 6 mm, about 1 mm to about 8 mm, about 2 mm to about 3 mm, about 2 mm to about 4 mm, about 2 mm to about 6 mm, about 2 mm to about 8 mm, about 2 mm to about 10 mm, about 3 mm to about 4 mm, about 3 mm to about 6 mm, about 3 mm to about 8 mm, about 3 mm to about 10 mm, about 5 mm to about 6 mm, about 5 mm to about 8 mm, about 5 mm to about 10 mm, about 6 mm to about 8 mm, about 6 mm to about 10 mm, or about 8 mm to about 10 mm.

The amount of grinding media used in the method above may be in the range of about 5- to about 20-fold of that of the solid in the dispersion comprising the at least one carbonaceous material and the coating material, about 5-fold, about 6-fold, about 7-fold, about 8-fold, about 9-fold, about 10-fold, about 11-fold, about 12-fold, about 13-fold, about 14-fold, about 15-fold, about 16-fold, about 17-fold, about 18-fold, about 19-fold, or about 20-fold. The preferred amount of the grinding media above may be about 5-fold of the solid in the dispersion comprising the at least one carbonaceous material and the coating material. As indicated above, the dispersion may comprise the solid (or powder) comprising the inventive coating formulation and one or more solvents.

As can be seen above, the ratio of the amount of the grinding media and the solid comprising the at least one carbonaceous material and the coating material may be adjusted or varied within the above range. Similarly, the amount of the solvent present in the dispersion may also be adjusted. For example when CNT is used as the at least one carbonaceous material, the ratio of the amount of the grinding media, the solid (comprising CNT and WC—Co) and ethanol (as solvent) may be of 12.5:2.5:1. Preferred grinding media may be a mixture of 5 mm and 10 mm of WC spherical particles (or balls) having a ratio of 1:1. This ratio may also be varied depending on the various factors such as the nature of solid and its particle size.

When roller milling is used, the milling step of the dispersion obtained above to reduce the particle size of the at least one carbonaceous material and the coating material to form a coating slurry, may be undertaken for a period of at least about 30 minutes to 48 hours, about 30 minutes, about one hour, about two hours, about three hours, about four hours, about five hours, about 6 hours, about 7 hours, about 8 hours, about 9 hours, about 10 hours, about 12 hours, about 24 hours, about 36 hours or about 48 hours.

For the particle size reduction using roller milling, the milling step of the dispersion above may be undertaken using a rotation speed in the range of 50 rotation per minute (rpm) to 500 rpm, 50 rpm to 100 rpm, 50 rpm to 200 rpm, 50 rpm to 300 rpm, 50 rpm to 400 rpm, 100 rpm to 200 rpm, 100 rpm to 300 rpm, 100 rpm to 400 rpm, 100 rpm to 500 rpm, 200 rpm to 300 rpm, 200 rpm to 400 rpm, 200 rpm to 500 rpm, 300 rpm to 400 rpm, 300 rpm to 500 rpm, or 400 rpm to 500 rpm.

The disclosure therefore provides the milling step using the roller mill to reduce the particle size of the CNT and WC—Co to form a coating slurry. The roller mill used herein may reduce or minimize any possible damage of the CNT during the milling step; therefore, the amount of the CNT present in the coating formulation before and after the milling step may be essentially the same. If changes occur (lesser CNT present in the coating formulation), these changes are minimal since the use of the roller mill significantly reduces the damage of CNT Similar as previously mentioned, the CNT used here may be a surface-functionalized CNT.

As indicated above, the functionalization of the at least one carbonaceous material (for example surface-functionalized CNT) may facilitate the dispersibility of the CNT, thereby the CNT that had been functionalized (on its surface for example) may not tend to self-agglomerate. In combination with the roller milling method above, when the surface-functionalized CNT is mixed with the coating material such as WC—Co, the homogeneously mixed powder may be obtained. It is to be understood that the agglomeration of CNT leads to a reduced deposition time, when the CNT together with the coating material forming a coating formulation is applied on the surface of a substrate. As demonstrated in the present disclosure, the CNT disclosed herein, which may have been functionalized and subjected to a milling process using roller milling, exhibits similar deposition rate suggesting that the CNT disclosed herein does not agglomerate.

It is to be understood that the step of dispersing the at least one carbonaceous material in the coating material may be undertaken at the same time as the milling step. Therefore, the dispersing step of the at least one carbonaceous material in the coating material and the particle size reducing step may proceed in one single step. Hence, the range of conditions for milling may be applicable to this one single step. Consequently, the effect of particle size reduction using a roller mill for example may be similar to that disclosed in the earlier section.

Exemplary, non-limiting embodiments of a substrate coated by a layer of a coating formulation, wherein the coating formulation comprises at least one carbonaceous material and a coating material, will now be disclosed.

The substrate coated by a layer of a coating formulation above may be selected from the substrate known in the art that may include metal or alloy such as iron, nickel, platinum, zirconium, palladium, cobalt, beryllium, molybdenum, hafnium, titanium, manganese, germanium, niobium, rhodium, uranium, and polymer such as glass, fused quartz and quartz. The substrate coated by a layer of the coating formulation as defined here is not limited to the above. Therefore, it may extend to other substrate suitable to be coated by the coating formulation of the present disclosure.

As shown in the present disclosure, decarburization of the coating formulation as defined herein, when applied onto the surface of the substrate above, may surprisingly not be observed. This may be attributed to the use of roller milling that allows the use of suitable concentration of the grinding media and rotation speed to reduce the damage of the at least one carbonaceous material in the coating formulation. Hence, it is to be understood that when there is no decarburization, there may be no change in the microstructure of the coating formulation and thus there may be no additional stress formed on the layer of a coating formulation.

When CNT is used as the at least one carbonaceous material and WC—Co is used as the coating material, surprisingly the dispersion of CNT into WC—Co using roller milling may not result in the change of the microstructure of the formulation such as the formation of W2C phases, which decarburizes the coating. The reduction in the decarburization may thus increase the wear resistance of the coatings.

As shown in the examples provided herein, the addition of CNT via roller milling as described above may increase the HCF lifetime of the carbide coatings. This may be attributed to the incorporation of CNT which leads to the formation of bridges between the WC particles. The linkage of the WC—Co particles, which binds them together, may increase the resistance towards crack initiation and propagation, which thus leads to an increase of the HCF lifetime. Further, the addition of CNT via ball milling to form CNT reinforced WC—Co coating may lead to the formation of a dense microstructure with splat-like structures. The splat-like structures are dominant in thermal barrier coating (TBC) structures to resist stress fractures and serve the same purpose in the WC—Co coating as defined herein.

As indicated above, the dispersed CNT may form bridges connecting the WC—Co particles in powder and in a coating layer form. The bridges may create a more tightly bonded WC—Co coating which may delay the time for the crack initiation and therefore increase the fatigue lifetime.

The CNT doped as sprayed coating above may have a better surface finish and may therefore exhibit an enhanced lubricity of the coating surface to promote smooth airflow over the surface. The CNT doped coating may also have a higher temperature capability as compared to the non-CNT doped coating and may therefore be able to withstand the flash temperature during frettage contact and enhance its frettage resistance. Accordingly, such coatings may be used for contact surface as well as for frettage resistance.

Additionally, the deposition time of the CNT reinforced WC—Co coating above may be comparable to that of the WC—Co coating. Hence, advantageously the same equipment or set up may be used. Given the above advantages of the CNT reinforced WC—Co coating, the service and maintenance costs for the coated substrate may be reduced.

The coating layer as defined above may have a thickness in the range of about 50 μm to about 200 μm, about 50 μm to about 60 μm, about 50 μm to about 70 μm, about 50 μm to about 80 μm, about 50 μm to about 90 μm, about 50 μm to about 100 μm, about 60 μm to about 70 μm, about 60 μm to about 80 μm, about 60 μm to about 90 μm, about 60 μm to about 100 μm, about 60 μm to about 200 μm, about 70 μm to about 80 μm, about 70 μm to about 90 μm, about 70 μm to about 100 μm, about 70 μm to about 200 μm, about 80 μm to about 90 μm, about 80 μm to about 100 μm, about 80 μm to about 200 μm, about 90 μm to about 100 μm, about 90 μm to about 200 μm, or about 100 μm to about 200 μm.

The hardness of one or more layers of the coating formulation as defined herein may be at least about 10 GPa, about 11 GPa, about 12 GPa, about 13 GPa, about 14 GPa, about 15 GPa, about 16 GPa, about 17 GPa, about 18 GPa, about 19 GPa, about 20 GPa, about 20 GPa, about 30 GPa, about 40 GPa, about 50 GPa, about 60 GPa, about 70 GPa, about 80 GPa, about 90 GPa or about 100 GPa.

The Young's modulus of one or more layers of the coating formulation is at least about 220 GPa, about 230 GPa, about 240 GPa, about 250 GPa, about 260 GPa, about 270 GPa, about 280 GPa, about 290 GPa, about 300 GPa, about 350 GPa, about 400 GPa, or about 500 GPa

Exemplary, non-limiting embodiments of a process for applying a coating slurry onto the surface of a substrate, wherein the coating slurry comprising at least one carbonaceous material and a coating material, will now be disclosed.

Provided in the present disclosure is the process for applying a coating slurry onto the surface of a substrate as defined above, wherein the coating slurry comprising at least one carbonaceous material and a coating material. The at least carbonaceous material used in the method above may be carbon nanotube (CNT), fullerene, graphite or combinations thereof.

If CNT is used as the at least one carbonaceous material, CNT used here may be similar to the previously defined CNT. Further, the at least one carbonaceous material may be functionalized for example surface-functionalized. Therefore, it is to be understood that when CNT is used as the at least one carbonaceous material, the CNT may be surface-functionalized.

Further, the process above may use the coating material selected from the group consisting of tungsten carbide (WC), WC—Co, titanium carbide, titanium nitride, silicon carbide, boron nitrate, rhenium diboride, titanium diboride and combinations thereof.

The process as defined above may comprise the step of applying the coating slurry onto the surface of the substrate, wherein such step may be undertaken via a thermal spray method. Under this method, the coating process may involve spraying the melted (or heated) coating formulation onto a surface of the substrate. The thermal spray method used herein may be selected from the group consisting of high velocity oxy-fuel (HVOF) coating spraying, high velocity air fuel (HVAF) coating spraying, warm spraying and cold spraying. The preferred thermal spray method used in the present disclosure is HVOF.

When HVOF is used, the step of applying the coating slurry onto the surface of the substrate may comprise the steps of:
1. feeding a mixture of gaseous or liquid fuel and oxygen into a combustion chamber, where they may be ignited and combusted to form a hot gas;
2. directing the resulting hot gas of step a) at a pressure in the range of about 1 to 10 MPa into a converging-diverging nozzle and allowing the hot gas to travel through a straight section. The jet velocity at the exit of the barrel may be at least of about 1000 m/s. Hence, it may exceed the speed of sound;
3. injecting a powder feed stock (comprising the CNT reinforced WC—Co particles) into the gas stream of step 2), which may cause an acceleration of the powder up to about 800 m/s; and
4. directing the stream of hot gas and the accelerated powder of step 3) towards the surface to be coated. During this process, the powder may partially melt in the stream, and may deposit upon the substrate.

The fuels above may be gases such as hydrogen, methane, propane, propylene, acetylene, natural gas, or mixtures thereof or liquids such as kerosene.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 is a picture of a scanning electron microscopy (SEM) image of the functionalized multi-walled carbon nanotube (MWCNT) of Example 1, with a magnification of 30,000×.

FIG. 2 is a picture of a SEM image of the coating formulation prepared according to Example 2. The coating formulation comprises 0.5 wt % to 2 wt % of CNT and tungsten carbide (WC)-17 wt % Co, with a magnification of 5,000×.

FIG. 3 is a number of pictures of cross-sectional SEM images of high velocity oxygen fuel (HVOF) spraying method for (a) WC-17 wt % Co coating, with a magnification of 200×; and (b) CNT reinforced WC-17 wt % Co coating, with a magnification of 400×according to Example 3.

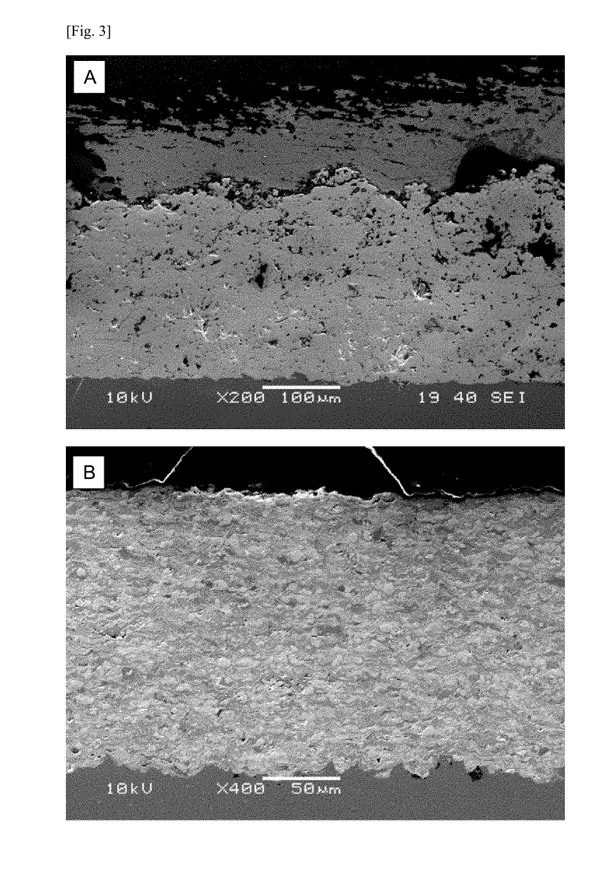

FIG. 4 is a number of graphs depicting the XRD spectra of WC-17 wt % Co coating according to Example 3 with various concentration of CNT (0%, 0.5%, 1% and 2%).

FIG. 5 is a number of graphs depicting (a) the hardness of WC-17 wt % Co coating according to Example 4a with various concentration of CNT (0%, 0.5%, 1% and 2%) and (b) the Young's modulus of WC-17 wt % Co coating according to Example 4a with various concentration of CNT (0%, 0.5%, 1% and 2%).

FIG. 6 is a graph showing the erosion resistance of WC-17 wt % Co coating according to Example 4b with various concentration of CNT (0%, 0.5%, 1% and 2%).

### EXAMPLES

Non-limiting examples of the invention and a comparative example will be further described in greater detail by reference to specific Examples, which should not be construed as in any way limiting the scope of the invention.

### Example 1: Surface-Functionalization of CNTs

0.8 g of the as purchased MWCNTs (obtained from mkNANO of Missisauga, Ontario of Canada) was refluxed in a mixture of 15 mL of concentrated nitric acid and 45 mL of concentrated sulfuric acid for a period in the range of 10 minutes to one hour.

The resulting surface-functionalized CNTs were washed several times by centrifuging in water until the pH of the CNTs suspension was about 7. Once the neutral pH is achieved, the CNTs were dried in a vacuum oven at 60° C. for about one hour.

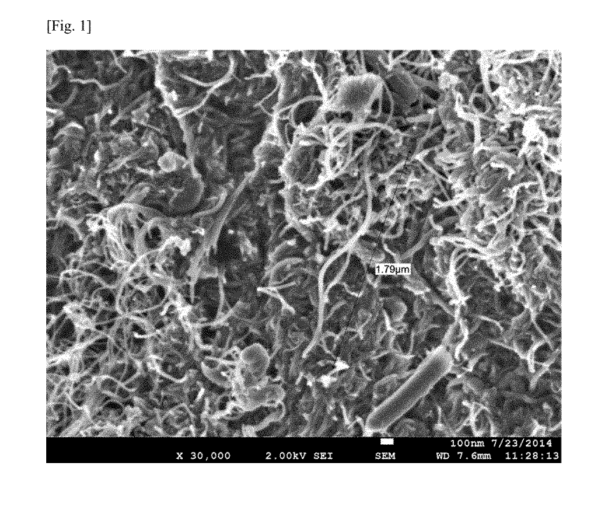

The dried CNTs above were then subjected to SEM analysis. As can be seen from FIG. 1, the CNTs that have been surface-functionalized are well-dispersed and do not form clusters suggesting that surface functionalization of CNTs significantly reduces the agglomeration of CNTs.

### Example 2: Dispersion of Functionalized CNTs in WC—Co Powder

The surface-functionalized CNTs obtained in Example 1 were dispersed in WC powder via roller milling with grinding media. The amount of CNTs used to form the coating formulation was varied from 0.5 wt % to 2 wt %, whereas the coating precursor used was WC-17 wt % Co powder. The formulation containing the surface-functionalized CNTs and WC—Co was then subjected to roller milling for about five hours with grinding media. The resulting formulation was subjected to SEM and Raman analyses.

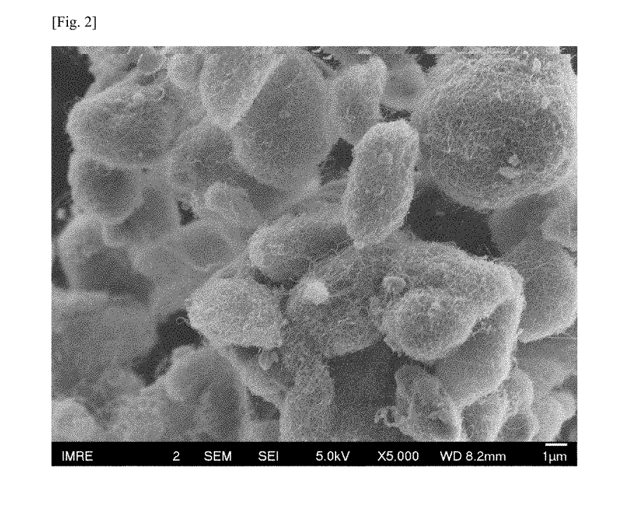

From the SEM image of FIG. 2, it can be seen that the CNT is well dispersed in the WC—Co matrix. More remarkably, some of the CNT particles appear to lie in between the WC—Co powders forming bridges with other powder particles. Further, as can be observed from FIG. 2, the size of the WC—Co powders are reduced upon roller milling that facilitates in the creation of a homogeneous mixture. Raman spectroscopy of the formulation powders at several spots reveals the homogeneity of the CNT dispersion and negligible damage for the CNTs during the mixing process.

### Example 3: Preparation of the Substrate Coated by a Layer of Coating Formulation of Example 2

The formulation powders obtained in Example 2 were deposited on Inconel 718 coupons via HVOF.

It is well known that deposition of WC—Co powders with small powder size via HVOF results in decarburization of the coating by the formation of W2C phases. The decarburization leads to a poor adhesion between the WC particles which then increases the inter-lamellar defects and reduces the density. This will in turn reduce the hardness and resistance to abrasive wear.

Hence, in addition to SEM analysis, additional characterization such as XRD was also used to examine the structure of the coatings.

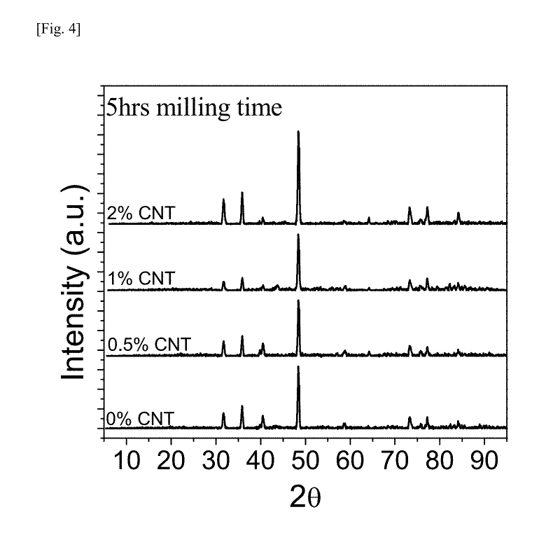

As can be seen from the XRD spectra in FIG. 4, W2C phases were not formed in the CNT reinforced WC—Co coating, suggesting that there was minimal or no decarburization. This lack of decarburization may be due to the short duration of milling, which did not significantly reduce the size of the WC—Co powders.

### Example 4: Mechanical Properties of the Coating Formulation of Example 2

a. Hardness and Young's Modulus

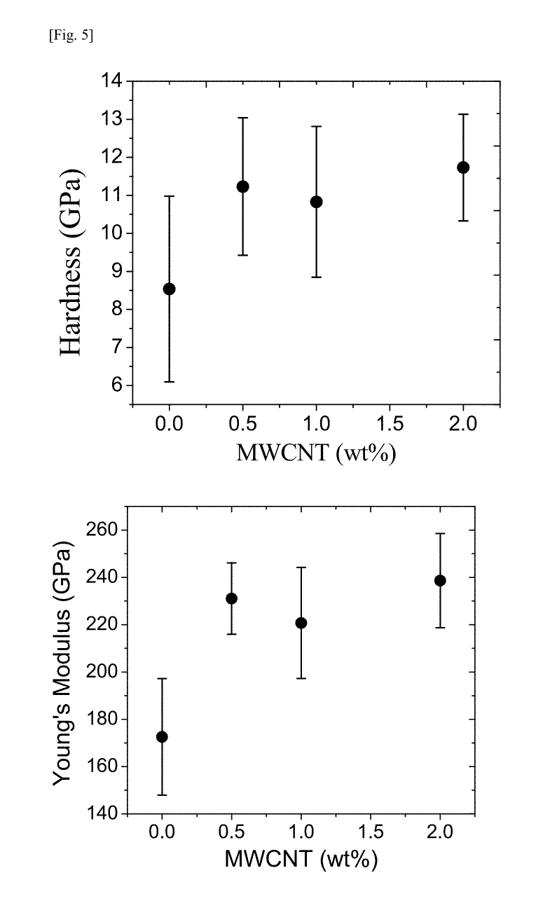

Mechanical properties of the coatings were measured by the nano-indentor. As can be seen from FIG. 5, the CNT reinforced WC—Co coating (referred as the inventive coating formulation in the present disclosure) possessed higher hardness and modulus values. The higher hardness is a result of the denser structure with the addition of the MWCNT while the increased modulus could be due to the addition of MWCNT which possesses superior modulus and the appearance of MWCNT in between the WC—Co particles.

b. Erosion Resistance

To evaluate the erosion resistance, the initial and final coating thickness and coating weight of the films were measured after bombarding the coatings with Al₂O₃ media for 75 seconds at 60 psi. Results in Table 1 below show that after the bombardment, the reduction of the coating thickness and weight of MWCNT-reinforced WC—Co coating was lesser as compared to the WC—Co coating. This indicates that the addition of MWCNT increases the erosion resistance. Erosion rate can be reduced as low as 2.5 fold as shown in the table (2% CNT+WC—Co vs. pure WC).

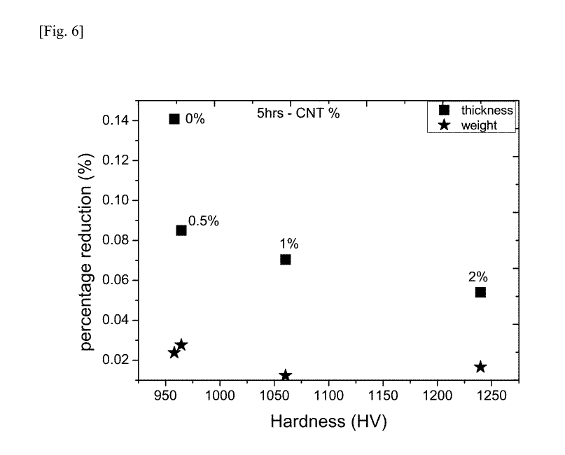

By comparing the erosion resistance to the microhardness measurements in FIG. 6, it can be concluded that the addition of CNT enhances the hardness of the coatings and that the enhanced erosion resistance is due to the increased hardness.

TABLE 1
Erosion Resistance (thickness) of WC—Co and
MWCNT-reinforced WC—Co coatings

| | Coupon thickness | | Change in | | |
|---|---|---|---|---|---|
| | (inch) | | thickness | | |
| Sample | Before | After | (inch) | Time (s) | PSI |
| Pure WC (M73) | 0.071 | 0.061 | 0.010 | 75 | 60 |
| 0.5% CNT + WC—Co | 0.071 | 0.065 | 0.006 | 75 | 60 |
| 1% CNT + WC—Co | 0.071 | 0.066 | 0.005 | 75 | 60 |
| 2% CNT + WC—Co | 0.074 | 0.070 | 0.004 | 75 | 60 |

c. High Cycle Fatigue (HCF) Testing

High cycle fatigue testing was also conducted on the CNT-reinforced WC—Co and WC—Co coatings according to ASTM E466-07. The following parameters were used: frequency of 29 Hz, stress ratio of 0.1, sinusoidal waveform and a maximum stress of 76.87 ksi. The results indicate that the WC—Co coating lasted for 7235 cycles while the CNT-reinforced coating lasted for 9236 cycles. This result suggests that the incorporation of CNT increases the HCF lifetime by 27.66%.

### INDUSTRIAL APPLICABILITY

Owing to the advantages of the CNT reinforced WC—Co coating as described in the present disclosure, for example high impact resistance, high HCF lifetime, high fracture toughness and no decarburization observed at high temperature, the coating formulation as defined herein may therefore be useful when applied onto a suitable substrate such as a part or component exposed to extreme environment (high temperature, corrosive). Hence, it is expected that the part or component coated by a layer of the coating formulation as defined herein may be used for various application such as in gas-turbine engines used in transportation, energy and defence sectors.

Further, since the CNT reinforced WC—Co coating as defined in the present disclosure exhibits excellent impact resistance, the part or component coated by the coating formulation as defined here may not undergo erosion due to ingestion of debris thus requiring minimum service and maintenance cost for the coated part or component. In addition, since the layer of the coating formulation also displays increased lubricity and increased temperature capability, the part or component coated by the coating formulation as defined herein may also be suitable for application in aviation, aerospace, automotive and marine and offshore.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A coating formulation comprising at least one carbonaceous material and a coating material.

2. The coating formulation of claim 1, wherein the at least one carbonaceous material is a carbon nanotube.

3. The coating formulation of claim 2, wherein the carbon nanotube is a single-walled carbon nanotube, a double-walled nanotube, a multi-walled carbon nanotube, an inorganic nanotube, a multibranched nanotube or combination thereof.

4. The coating formulation of claim 1, wherein the at least one carbonaceous material is surface-functionalized.

5. The coating formulation of claim 1, wherein the coating material is selected from the group consisting of tungsten carbide (WC), titanium carbide, titanium nitride, silicon carbide, boron nitrate, rhenium diboride, titanium diboride and combinations thereof.

6. The coating formulation of claim 1, wherein the at least one carbonaceous material is present in the range of 0.05 to 5 wt % based on the total weight of the coating formulation.

7. A method for preparing a coating formulation comprising at least one carbonaceous material and a coating material comprising the step of dispersing the at least one carbonaceous material in the coating material.

8. The method of claim 7, wherein the at least one carbonaceous material is a carbon nanotube.

9. The method of claim 8, wherein the carbon nanotube is a single-walled carbon nanotube, a multi-walled carbon nanotube or combination thereof.

10. The method of claim 7, wherein the at least one carbonaceous material is surface-functionalized.

11. The method of claim 7, wherein the coating material is selected from the group consisting of tungsten carbide (WC), titanium carbide, titanium nitride, silicon carbide, boron nitrate, rhenium diboride, titanium diboride and combinations thereof.

12. The method of claim 7 further comprising the step of milling the dispersion to reduce the particle size of the at least one carbonaceous material and the coating material to form a coating slurry.

13. The method of claim 12, wherein the milling step is undertaken for a period of at least 3 hours.

14. The method of claim 12, wherein the milling step comprises the step of using at least one grinding medium.

15. A substrate coated by a layer of a coating formulation, wherein the coating formulation comprises at least one carbonaceous material and a coating material.

16. The substrate of claim 15, wherein the coating layer has a thickness in the range of 0.5 to 5 mm.

17. The substrate of claim 15, wherein the hardness of the substrate coated by a layer of the coating formulation is at least 10 GPa.

18. The substrate of claim 15, wherein the Young's modulus of the substrate coated by a layer of the coating formulation is at least 220 GPa.
